(19) United States
(12) Patent Application Publication
(10) Pub. No.: US 2009/0046645 A1
(43) Pub. Date: Feb. 19, 2009

(54) Uplink Reference Signal Sequence Assignments in Wireless Networks

(76) Inventors: Pierre BERTRAND, Antibes (FR); Tarik Muharemovic, Dallas, TX (US); Zukang Shen, Richardson, TX (US)

Correspondence Address: TEXAS INSTRUMENTS INCORPORATED, P O BOX 655474, M/S 3999, DALLAS, TX, 75265, US

(21) Appl. No.: 12/189,277

(22) Filed: Aug. 11, 2008

Related U.S. Application Data
(60) Provisional application No. 60/955,454, filed on Aug. 13, 2007.

(51) Int. Cl. H04Q 7/00

(52) U.S. Cl. 370/329

(57) ABSTRACT

Transmission of sequences in wireless networks from a user equipment (UE) includes various types of reference signals, such as a sounding reference signal (SRS) and a physical uplink control channel (PUCCH) symbol. The UE receives an indication of a reference signal sequence group number u, wherein physical uplink control channel (PUCCH) sequences are divided into groups having at least one sequence each and wherein sounding reference signal (SRS) sequences are divided into groups having at least one sequence each. The UE produces a sequence from an SRS sequence group with the sequence group number u when an SRS is to be transmitted and produces a sequence from a PUCCH sequence group with the sequence group number u when a PUCCH symbol is to be transmitted. The UE produces a transmission signal using the produced sequence.

### CLAIM OF PRIORITY

This application for Patent claims priority to U.S. Provisional Application No. 60/955,454 (attorney docket TI-65197PS) entitled “Uplink Reference Signal Sequence Assignments in Wireless Networks” filed Aug. 13, 2007, incorporated by reference herein.

### FIELD OF THE INVENTION

This invention generally relates to wireless cellular communication, and in particular to sequence selection signaling scheme for use in orthogonal frequency division multiple access (OFDMA), DFT-spread OFDMA, and single carrier frequency division multiple access (SC-FDMA) systems.

### BACKGROUND OF THE INVENTION

Wireless cellular communication networks incorporate a number of mobile UEs and a number of NodeBs. A NodeB is generally a fixed station, and may also be called a base transceiver system (BTS), an access point (AP), a base station (BS), or some other equivalent terminology. As improvements of networks are made, the NodeB functionality evolves, so a NodeB is sometimes also referred to as an evolved NodeB (eNB). In general, NodeB hardware, when deployed, is fixed and stationary, while the UE hardware is portable.

In contrast to NodeB, the mobile UE can comprise portable hardware. User equipment (UE), also commonly referred to as a terminal or a mobile station, may be fixed or mobile device and may be a wireless device, a cellular phone, a personal digital assistant (PDA), a wireless modem card, and so on. Uplink communication (UL) refers to a communication from the mobile UE to the NodeB, whereas downlink (DL) refers to communication from the NodeB to the mobile UE. Each NodeB contains radio frequency transmitter(s) and the receiver(s) used to communicate directly with the mobiles, which move freely around it. Similarly, each mobile UE contains radio frequency transmitter(s) and the receiver(s) used to communicate directly with the NodeB. In cellular networks, the mobiles cannot communicate directly with each other but have to communicate with the NodeB.

Control information bits are transmitted, for example, in the uplink (UL), for several purposes. For instance, Downlink Hybrid Automatic Repeat ReQuest (HARQ) requires at least one bit of ACK/NACK transmitted in the uplink, indicating successful or failed circular redundancy check(s) (CRC). Moreover, a one bit scheduling request indicator (SRI) is transmitted in uplink, when UE has new data arrival for transmission in uplink. Furthermore, an indicator of downlink channel quality (CQI) needs to be transmitted in the uplink to support mobile UE scheduling in the downlink. While CQI may be transmitted based on a periodic or triggered mechanism, the ACK/NACK needs to be transmitted in a timely manner to support the HARQ operation. Note that ACK/NACK is sometimes denoted as ACKNAK or just simply ACK, or any other equivalent term. As seen from this example, some elements of the control information should be provided additional protection, when compared with other information. For instance, the ACK/NACK information is typically required to be highly reliable in order to support an appropriate and accurate HARQ operation. This uplink control information is typically transmitted using the physical uplink control channel (PUCCH), as defined by the 3GPP working groups (WG), for evolved universal terrestrial radio access (EUTRA). The EUTRA is sometimes also referred to as 3GPP long-term evolution (3GPP LTE). The structure of the PUCCH is designed to provide sufficiently high transmission reliability.

In addition to PUCCH, the EUTRA standard also defines a physical uplink shared channel (PUSCH), intended for transmission of uplink user data. The Physical Uplink Shared Channel (PUSCH) can be dynamically scheduled. This means that time-frequency resources of PUSCH are re-allocated every sub-frame. This (re)allocation is communicated to the mobile UE using the Physical Downlink Control Channel (PDCCH). Alternatively, resources of the PUSCH can be allocated semi-statically, via the mechanism of persistent scheduling. Thus, any given time-frequency PUSCH resource can possibly be used by any mobile UE, depending on the scheduler allocation. Physical Uplink Control Channel (PUCCH) is different than the PUSCH, and the PUCCH is used for transmission of uplink control information (UCI). Frequency resources which are allocated for PUCCH are found at the two extreme edges of the uplink frequency spectrum. In contrast, frequency resources which are used for PUSCH are in between. Since PUSCH is designed for transmission of user data, re-transmissions are possible, and PUSCH is expected to be generally scheduled with less stand-alone sub-frame reliability than PUCCH. The general operations of the physical channels are described in the EUTRA specifications, for example: “3^{rd} Generation Partnership Project; Technical Specification Group Radio Access Network; Evolved Universal Terrestrial Radio Access (E-UTRA); Physical Channels and Modulation (Release 8).”

A reference signal (RS) is a pre-defined signal, pre-known to both transmitter and receiver. The RS can generally be thought of as deterministic from the perspective of both transmitter and receiver. The RS is typically transmitted in order for the receiver to estimate the signal propagation medium. This process is also known as “channel estimation.” Thus, an RS can be transmitted to facilitate channel estimation. Upon deriving channel estimates, these estimates are used for demodulation of transmitted information. This type of RS is sometimes referred to as De-Modulation RS or DM RS. Note that RS can also be transmitted for other purposes, such as channel sounding (SRS), synchronization, or any other purpose. Also note that Reference Signal (RS) can be sometimes called the pilot signal, or the training signal, or any other equivalent term. The sounding reference signal (SRS) is defined in support of frequency dependent scheduling, link adaptation, power control and UL synchronization maintenance. These UL RSs can have different bandwidths as they can occupy different numbers of resource blocks (RB). They use constant amplitude zero autocorrelation (CAZAC) sequences which zero autocorrelation property allows multiplexing in orthogonal manner different cyclic shifts of the same sequence. The cross-correlation property can be randomized through sequence hopping and cyclic shift hopping.

A current status of PUCCH DM RS and SRS definition within the 3GPP working group is outlined in R1-072584 “Way Forward for PUSCH RS” and in R1073815 “Draft Report of 3GPP TSG RAN WG1 #49b v0.3.0, 25-29 June, 2007.

### BRIEF DESCRIPTION OF THE DRAWINGS

Particular embodiments in accordance with the invention will now be described, by way of example only, and with reference to the accompanying drawings:

FIG. 1 is a pictorial of an illustrative telecommunications network that employs an embodiment of a slot structure in which an SRS and a PUCCH RS are generated using a common index value;

FIG. 2 is an illustration of a slot structure used for transmission in the PUCCH or PUSCH of FIG. 1;

FIG. 3 is a block diagram of an illustrative transmitter for transmitting an SRS or a PUCCH RS in a slot structure of FIG. 2;

FIG. 4 is a flow diagram illustrating sequence selection for the SRS and PUCCH RS symbols;

FIG. 5 is a block diagram of a Node B and a User Equipment for use in the network system of FIG. 1; and

FIG. 6 is a block diagram of a cellular phone for use in the network of FIG. 1.

### DETAILED DESCRIPTION OF EMBODIMENTS OF THE INVENTION

The various uplink reference signals (RS), including the sounding reference signal (SRS) and the De-Modulation RS or DM RS, can have different bandwidths as they can occupy different numbers of resource blocks (RB). They use constant amplitude zero autocorrelation (CAZAC) sequences which zero autocorrelation property allows multiplexing in orthogonal manner different cyclic shifts of the same sequence. The cross-correlation property can be randomized through sequence hopping and cyclic shift hopping. An embodiment of the present invention provides an efficient solution for assigning the sequences of all these different UL RSs to each UE.

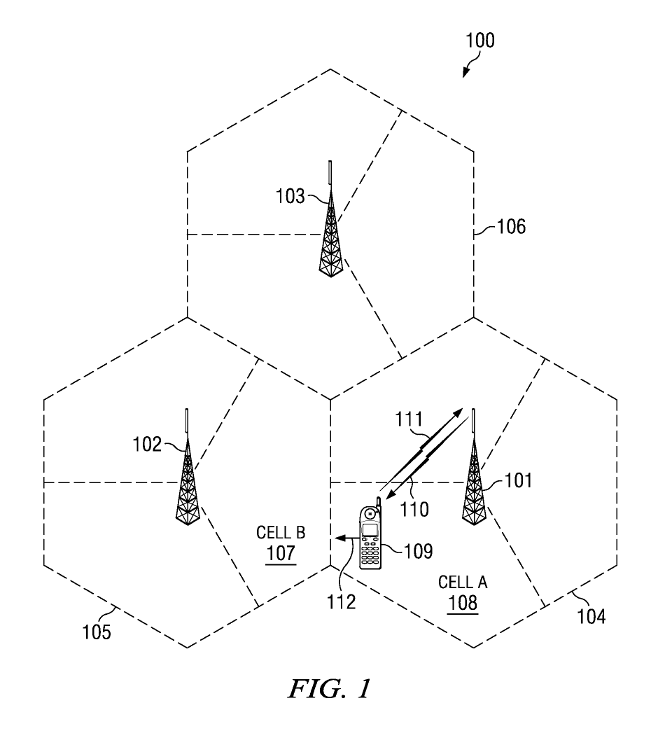

FIG. 1 shows an exemplary wireless telecommunications network 100. The illustrative telecommunications network includes representative base stations 101, 102, and 103; however, a telecommunications network necessarily includes many more base stations. Each of base stations 101, 102, and 103 are operable over corresponding coverage areas 104, 105, and 106. Each base station's coverage area is further divided into cells. In the illustrated network, each base station's coverage area is divided into three cells. Handset or other UE 109 is shown in Cell A 108, which is within coverage area 104 of base station 101. Base station 101 is transmitting to and receiving transmissions from UE 109 via downlink 110 and uplink 111. As UE 109 moves out of Cell A 108, and into Cell B 107, UE 109 may be handed over to base station 102. Because UE 109 is synchronized with base station 101, UE 109 must employ non-synchronized random access to initiate handover to base station 102. Various types of reference signals are transmitted on uplink channel 111.

A UE in a cell may be stationary such as within a home or office, or may be moving while a user is walking or riding in a vehicle. UE 109 moves within cell 108 with a velocity 112 relative to base station 102.

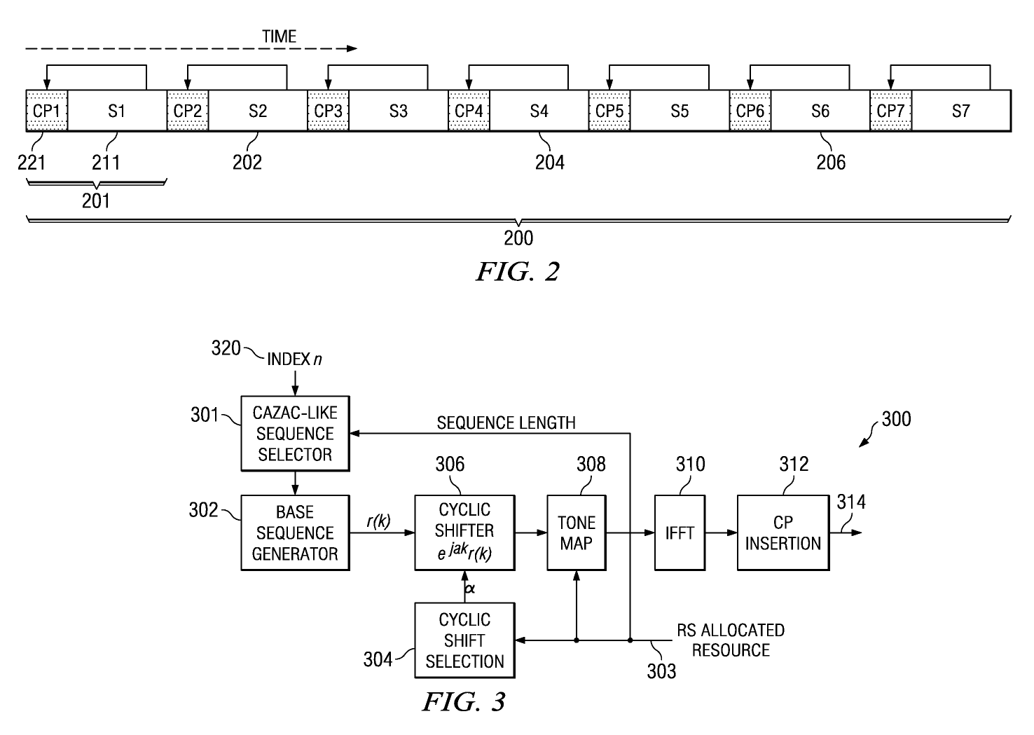

FIG. 2 is an illustration of a slot structure 200 used for transmission in the PUCCH or PUSCH of FIG. 1. There are seven SC-OFDMA symbols S1-S7, indicated generally at 201, which are realized through a DFT-spread OFDMA transmission. Slot 200 duration is 0.5 ms in this embodiment. All blocks 211 are preceded by a cyclic prefix transmission 221 to protect the corresponding data 211 against channel delay spread and the respective multi-path propagation. For low-speed UEs, a reference signal (RS) may be located in symbol S4 204, and is based on Zadoff-Chu CAZAC sequences. For high speed UEs, an RS may be placed in symbol S2 202 and S6 206, for example. Typically, a sub-frame is formed by two sequential slots. A synchronization-RS may be placed in a selected symbol once every n-subframes, where n may vary with speed of UEs in the cell. Similarly, an SRS may be placed in a selected symbol periodically as needed. As mentioned earlier, these UL RSs can have different bandwidths as they can occupy different numbers of resource blocks (RB) of a transmission frequency spectrum. A reference signal is a signal which is pre-known (known prior to the transmission) to both a transmitter and a receiver. At times, non-modified reference signal is transmitted to facilitate channel estimation at the receiver. At other times, a modulated reference signal can be transmitted where the resultant transmission is information-bearing.

As used herein, the term “channel”, “block,” and “OFDMA symbol” all generally refer to each of the seven information carrying portions 201 of slot structure 200.

### Reference Signal Sequence Assignment

A simple solution to manage and signal the sequences and cyclic shifts to UEs in a cell for the different RSs and their different RB allocations will now be described. RS sequences are generated from Zadoff-Chu (ZC) sequences, which have the Constant Amplitude Zero Autocorrelation (CAZAC) property. Zadoff-Chu sequences are defined as:

$$\begin{matrix}{a}_{k} = exp [ j2π \frac{n}{{N}_{ZC}} ( \frac{k ( k + 1 )}{2} + qk ) ] ; & k = 0 , … , {N}_{ZC} - 1\end{matrix} \qquad ( 1 )$$

where n, referred to as the sequence index, is relatively prime to N_{ZC}, N_{ZC} the sequence length is odd, and q any integer. The CAZAC property allows generating orthogonal sequences by cyclically shifting the same root sequence, also referred to as base sequence. The term “sequence index” may also be referred to as a “generating index,” a “global sequence index,” or other equivalent terms.

In addition, if N_{ZC} is the sequence length, the number Nₛ of ZC sequences with optimal cross-correlation (=\sqrt{N_{ZC}}) is maximized and equals N_{ZC}−1 when N_{ZC} is prime. The RS sequences are mapped in frequency at the IDFT input of the SC-FDMA transmitter, as will be described in more detail with respect to FIG. 3, so that their sequence lengths must be equal to the number sub-carriers allocated to the RS transmission. The sub-carriers are allocated by resource blocks (RBs) where one RB occupies twelve sub-carriers. As a result, the RS sequence lengths are integer multiple of twelve, so cannot be prime. Two methods are foreseen so far to circumvent this issue: using the closest prime-length ZC sequence to 12n and either truncate or cyclic-extend it. Table 1 below gives an example of the length of various sequences and associated ZC length. As can be observed, for small numbers (1-2) of allocated RBs, the number N_{ZC}−1 of ZC sequences with optimal cross-correlation is small (12 for 1 RB and 28 for 2 RBs), which is an issue for cell planning, especially if part of these sequences are further reserved for hopping within a sequence group. To circumvent this issue, the number of sequences with good cross correlation can be extended to 33 in both cases through computer-generated CAZAC sequences, as described in more detail in R1-072848 “Design of CAZAC Sequences for Small RB Allocations in E-UTRA UL”. In the remaining of the document we refer to “CAZAC-like” sequence when addressing the various sequences types used to generate RS sequences.

TABLE 1
UL RS sequences lengths for various RB allocations

| | | |
|---|---|---|
| UL RS BW | Sequence | ZC length |

| RBs | MHz | length | ZC length (ext) | (trunc) |
|---|---|---|---|---|
| 1 | 0.18 | 12 | 11 | 13 |
| 2 | 0.36 | 24 | 23 | 29 |
| 3 | 0.54 | 36 | 31 | 37 |
| 4 | 0.72 | 48 | 47 | 53 |
| 5 | 0.9 | 60 | 59 | 61 |
| 6 | 1.08 | 72 | 71 | 73 |
| 8 | 1.44 | 96 | 89 | 97 |
| 10 | 1.8 | 120 | 113 | 127 |
| 12 | 2.16 | 144 | 139 | 149 |
| 25 | 4.5 | 300 | 293 | 307 |

### Sequence Groups

A group of base sequences defines a number of base sequence indexes n (as e.g. used in Equation (1)) to be used for hopping, given a sequence length. The base sequence index n ranges from 0 to the total number of available sequences Nₛ. It is referred to as the global sequence index. Base sequence groups are planned among cells (PUCCH RS and SRS) or among eNodeBs (PUSCH DM RS). Group-sequence planning is done over a range of Ng base sequence groups indexed by u=0, . . . , N_{g}−1. A global base sequence index n is uniquely defined, through a closed-form expression, by a group index u and a local base sequence index v within the group, v ε 55 0, . . . , S(u)−1} where S(u)−1 is the size of group u. The minimum number Nₛ₋ₘᵢₙ of available CAZAC-like sequences with optimal cross-correlation properties results from 1-RB allocation and is maximized through computer generated CAZAC sequences, as discussed above.

In one embodiment, Nₛ₋ₘᵢₙ=33 and N_{g}=11, thus allowing sequence hopping within a group even for the smaller allocations. For one or two RBs there are 33 random CAZAC sequences available; n=0, . . . ,32. For three RBs (3 RB), which have a sequence length of 36, there are 30 extension or 36 truncation ZC sequences available, indexed by n.

With truncation, there may be a single sequence allocation method per sequence group for one to three RB allocations resulting in all eleven sequence groups u having three sequences for hopping.

The sequences allocated to the sequence group u are n=3u, 3u+1, 3u+2. For the 3 RB allocation, sequences n=33-35 are left unused.

For four RBs (sequence length 48) there are 46 (extension) or 52 (truncation) ZC sequences available, indexed by n, and resulting in all eleven sequence groups u having four sequences for hopping. The sequences allocated to the sequence group u are n=4u, 4u+1, 4u+2, 4u+3. Sequences n=44-51 are left unused.

For five RBs (sequence length 60) there are 58 (extension) or 60 (truncation) ZC sequences available, indexed by n, and resulting in all eleven sequence groups u having five sequences for hopping. The sequences allocated to the sequence group u are n=5u, 5u+1, 5u+2, 5u+3, 5u+4. Sequences n=55-59 are left unused.

For six RBs (sequence length 72) there are 70 (extension) or 72 (truncation) ZC sequences available, indexed by n, and resulting in all eleven sequence groups u having six sequences for hopping. The sequences allocated to the sequence group u are n=6u, 6u+1, 6u+2, 6u+3, 6u+4, 6u+5. Sequences n=66-71 are left unused.

For eight RBs (sequence length 96) there are 88 (extension) or 96 (truncation) ZC sequences available, indexed by n, and resulting in all eleven sequence groups u having eight sequences for hopping. The sequences allocated to the sequence group u are n=8u, 8u+1, 8u+2, 8u+3, 8u+4, 8u+5, 8u+6, 8u+7. Sequences n=88-95 are left unused.

A similar enumeration may be continued for larger numbers of resource blocks, as suggested in Table 1. This RS sequence allocation method may be generalized as follows.

For N_{RB}=1-3 RB allocations: there are 33 random CAZAC sequences available (1-2 RBs) or 36 ZC sequences available (3 RBs), indexed by n. All eleven base sequence groups u have three base sequences for hopping, indexed by v ε {0, 1, 2}. The base sequence indexes n allocated to the base sequence group u are given by n=3u+v. For the 3 RB allocation, base sequences n=33-35 are left unused.

For N_{RB}>3 RBs allocations: there are N_{ZC}−1 ZC base sequences available, indexed by n, where N_{ZC} is the closest prime number to 12N_{RB}, higher than 12N_{RB}; all eleven base sequence groups u have N_{RB} base sequences for hopping, indexed by v ε {0, 1, . . . N_{RB}−1}. The base sequence indexes n allocated to the base sequence group u are given by n=N_{RB}u+v. Base sequences n=11N_{RB} to N_{ZC}−2 are left unused.

This implicit mapping of sequences to group sequences is simple and works fine for all RBs as long as truncation is chosen instead of extension. Furthermore, the sequences which are left unused could be assigned to certain groups in any form. In addition, the definition of groups in the exemplary embodiment can be changed. For instance, instead of group u being defined by sequences n=ru+v, v ε {0, 1, . . . N_{RB}−1}, it could alternatively be defined using modulo operation. For example, group u can be defined as the group of sequences whose indexes, when divided by N_{g} (number of groups), give a remainder “u.” In this manner, some groups can have more sequences then others, when the total number of sequences is not a multiple of the number of groups.

Another point one can observe is that the higher the RB allocation, i.e. the better the UE's geometry, the higher the used ZC sequence index for a given group u. Therefore, in another embodiment, n is re-ordered by increasing cubic metric (CM). This implicitly allocates high CM ZC sequences to good geometry UEs.

In another embodiment, Nₛ₋ₘᵢₙ=N_{g}=30 and sequence extension is used as the CAZAC sequence length adjustment method. In this case, as can be seen from Table 1, there can only be one base sequence per group up to five RBs allocation size of 60 sequences, and intra-group sequence hopping is only possible for six RBs onward. However, larger number of groups provides more flexibility for group planning and/or longer hopping pattern if group base sequence hopping is used. In this embodiment, for those allocation sizes supporting only one base sequence per group, the base sequence group index u can be merged with the unique base sequence index n it defines. For the following description, this embodiment is used as reference example and assumes that the PUCCH RS allocation size, which is typically small, limits to one the number of base sequence index values (v=0) used per group. This does not preclude though that SRS, which allocation size is typically large, can use multiple base sequence index values v per group, for hopping purpose.

Multiple-input and multiple-output, or MIMO is the use of multiple antennas at both the transmitter and receiver to improve communication performance. Each mobile device has at least one transmitter. If virtual MIMO or Spatial division multiple access (SDMA) is introduced the data rate in the uplink direction can be increased depending on the number of antennas at the base station. With this technology more than one mobile can reuse the same resources

### Signaling of Base Sequence Groups

Within a cell, the PUSCH demodulation (DM) RS of a UE is multiplexed in time and frequency with other UE's DM RSs. Cyclic shift multiplexing is foreseen between UEs in case of SDMA cells only. Therefore, for the nominal case (non SDMA), the cyclic shifts can be used to multiplex in orthogonal manner the synchronous cells of a given eNodeB. As a result, the base sequence groups of the PUSCH DM RS are allocated on a per eNodeB basis for the nominal case or on a per cell basis for the SDMA case.

Within a cell, the PUCCH RSs of a UE are multiplexed in time, frequency and cyclic shifts with other UE's PUCCH RSs. Therefore the cyclic shifts are fully utilized and cannot be used to multiplex in orthogonal manner the cells of a given eNodeB. As a result, the base sequence groups of the PUCCH RSs are allocated on a per cell basis.

Within a cell, the SRS of a UE is multiplexed in time, frequency and cyclic shifts with other UE's SRSs. Therefore the cyclic shifts are fully utilized and cannot be used to multiplex in orthogonal manner the cells of a given eNodeB. As a result, the base sequence groups of the SRSs are allocated on a per cell basis.

From the above, it can be determined that the PUSCH DM RS base sequence groups need to be allocated separately from the PUCCH RS and SRS base sequence groups, but the PUCCH RS and SRS can be allocated the same base sequence group in a cell. In the case of explicit base sequence group signaling, this limits to two the number of base sequence group indexes that need to be broadcast in a cell in support of all UL RSs.

FIG. 3 is a block diagram of an illustrative transmitter 300 for transmitting an SRS or a PUCCH RS in a slot structure of FIG. 2. In one embodiment, elements of the transmitter may be implemented as components in a fixed or programmable processor by executing instructions stored in memory. Transmitter 300 is used to select and perform the RS transmission as follows. The UE performs selection of the CAZAC-like (e.g. ZC or extended ZC or zero-autocorrelation QPSK computer-generated) base sequence using the CAZAC-like Root Sequence Selector 301, using a global index value n 320 identified from the base sequence group assigned by the eNodeB for both SRS and PUCCH transmissions in the current cell served by that eNodeB. Assuming the above embodiment where PUCCH supports only one base sequence index per group and sequence hopping is precluded for the SRS, this simplifies to the eNodeB directly indicating the base sequence index n to the UEs. In another embodiment, the base sequence group index u is indicated by the eNodeB. Selector 301 selects a base sequence according to the sequence length resulting from the RS allocated resource 303 and the global index n from an ordered set of sequences as defined above. In one embodiment, information that represents the ordered set of sequences is stored in memory accessible by selector 301. Index n is then used to select, given the sequence length, the indicated sequence from the stored ordered list of sequences.

In some embodiments, the same global index value n is used by the UE for all SRS and PUCCH transmissions, and is derived from the first local index value v=0 in the base sequence group. In another embodiment, the selection of the local index value v (and consequently, the global one, n) may be combined with a slot index nₛ that is provided by the eNodeB as part of a resource allocation process. Sequence hopping can then be performed based on changing slot index values which produce a corresponding different local base sequence index value v from the base sequence group, and consequently a different global base sequence index n as well.

The UE generates the CAZAC-like (e.g. ZC or extended ZC or zero-autocorrelation QPSK computer-generated) sequence using base sequence generator 302. The eNB provides the UE with an RS resource allocation 303 allowing inserting the UE in the RS multiplex. This RS resource index directly or indirectly defines 304 a cyclic shift value α. The base sequence is then shifted by cyclic shifter 306 using shift values provided by cyclic shift selection module 304.

The resulting frequency domain signal is mapped onto a designated set of tones (sub-carriers) using the Tone Map 308. The Tone Map 308 performs all appropriate frequency multiplexing (tone level as well as RB level) according to the RS resource allocation 303. The UE next performs in inverse fast Fourier transform (IFFT) of the mapped signal using IFFT 310. A cyclic prefix is created and added in module 312 to form a final fully formed uplink signal 314.

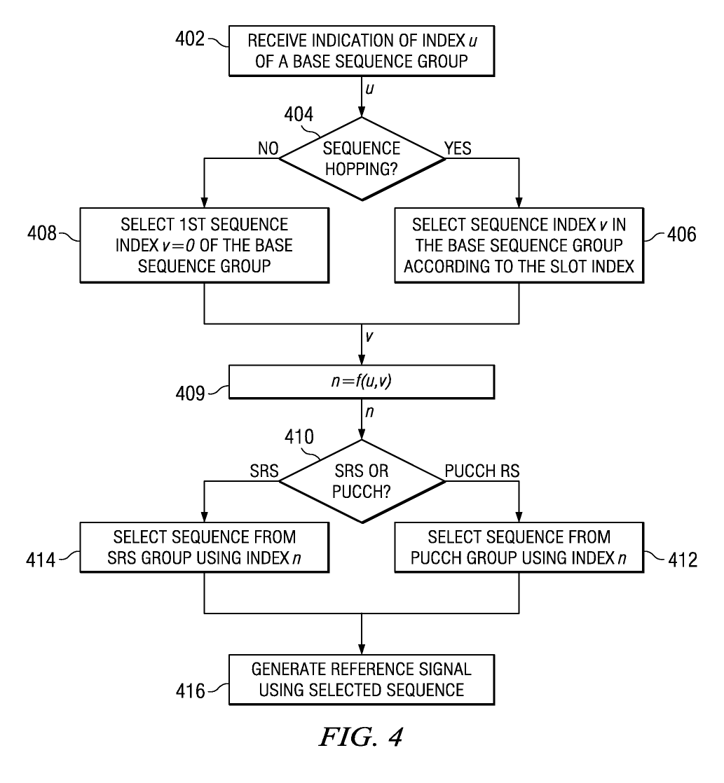

FIG. 4 is a flow diagram illustrating sequence selection for the SRS and PUCCH RS sequences. As described above, for a given cell served by an eNodeB, the eNodeB indicates 402 a base sequence group index u to each UE within the given cell that indicates which base sequences the UE is to use for forming PUCCH RSs and also for forming SRSs. In one embodiment, the index u is explicitly broadcasted by the eNB to the UEs. In another embodiment, the index u is derived implicitly by the UE from other broadcasted parameter(s) such as e.g. the cell identifier. In another embodiment, the index u defines the origin u(0) of a base sequence group hopping pattern and the UE derives the base sequence group index u(nₛ) to use in slot nₛ according to the slot number nₛ and a pre-defined hopping pattern. In one embodiment, a PUCCH RS and an SRS are formed using the same local base sequence index v from base sequence group index u. In another embodiment, one base sequence index is used for PUCCH RS and a different base sequence index is used for SRS. This is the case for example when, as mentioned above, the SRS base sequence index hops across slots within the sequence group while the PUCCH-RS base sequence index remains the same. However, in this case the same base sequence group index value u is used to select a base sequence index for either type of RS. Therefore the UE first determines 404 if sequence hopping is enabled. This can result from the combination of several conditions such as e.g. the sequence hopping feature is enabled by the eNodeB and the resource allocation comprises sufficient number of RBs for the UE to use more than one sequence index value per group. If yes, then the UE selects 406 the local base sequence index v in the base sequence group depending on the current slot index. If not, the UE selects 408 the first local base sequence index v=0 in the base sequence group. Then, the UE derives the global base sequence index n from a closed form expression 109 involving u and v. This index n now feeds the transmitter 300 of FIG. 3.

As mentioned above, a single sequence index u is used to generate base sequences of different lengths. In addition, in one embodiment, different types of sequences may be used depending on the sequence length: for example, it is mentioned above that, in Table 1, for one and two RB allocations, computer generated sequences can be used instead of extended ZC sequences. The sequence length depends on the RS allocation size which is likely to be different for the SRS and the PUCCH. Therefore, the same sequence index n points to two different base sequences in practice, depending on whether PUCCH or SRS is to be transmitted. This is described in the flow diagram of FIG. 4 where the UE determines 410 which type of RS is to be formed. If a PUCCH RS is to be formed, then a base sequence is selected 412 from an ordered set of sequences intended for PUCCH RSs using base sequence index value n. However, if the UE determines an SRS is to be formed, then a base sequence is selected 414 from an ordered set of sequences intended for SRSs using base sequence index value n. Once the base sequence is selected, then the appropriate reference signal is generated 416 using the resource allocation 303 information to define a cyclic shift value.

In one embodiment, if an SRS is to be transmitted, then a sequence is produced 414 from an SRS sequence group with the sequence group number u; wherein a plurality of SRS sequences are divided into groups having at least one sequence each. If a PUCCH symbol is to be transmitted, then a sequence is produced 412 from a PUCCH sequence group with the sequence group number u; wherein a plurality of PUCCH sequences are divided into groups having at least one sequence each. The sequence may be produced using the SRS sequence group number u and using a sequence number v; wherein v is a sequence number within the group u. A generating index n may be produced from u and v; wherein the sequence is produced using the generating index n. The sequence may also be produced using the PUCCH sequence group number u and using a stored look-up table, wherein the stored look-up table is accessed using the number u. A PUCCH sequence group with group number u may be pre-stored in a local memory for use in producing the sequence. Similarly, an SRS sequence group with group number u may be pre-stored in the local memory for use in producing the sequence.

In one embodiment, the SRS group with group number u comprises exactly one sequence, and the PUCCH group with group number u comprises exactly one sequence. In another embodiment, the SRS group with group number u comprises exactly two sequences, and the PUCCH group with group number u comprises exactly one sequence. In another embodiment, the two sequences from the SRS group with group number u are identified using the sequence number v; wherein v is selected from the set comprising {0,1}; and wherein v is configured to a default value of v=0; In another embodiment, two sequences from the SRS group with group number u are identified using the sequence number v; wherein v is selected from the set comprising {0,1}; and v is set to be 0 for a first transmission; and v is set to be 1 for a second transmission.

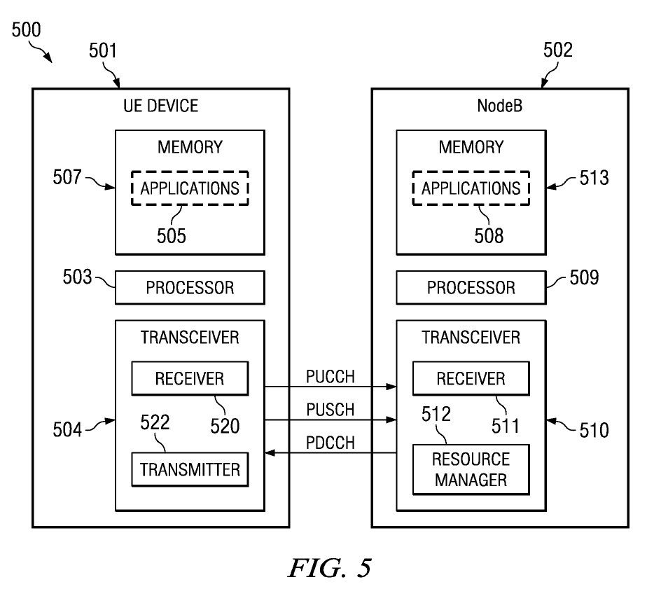

FIG. 5 is a block diagram illustrating operation of an eNB and a mobile UE in the network system of FIG. 1. As shown in FIG. 5, wireless networking system 500 comprises a mobile UE device 501 in communication with an eNB 502. The mobile UE device 501 may represent any of a variety of devices such as a server, a desktop computer, a laptop computer, a cellular phone, a Personal Digital Assistant (PDA), a smart phone or other electronic devices. In some embodiments, the electronic mobile UE device 501 communicates with the eNB 502 based on a LTE or E-UTRAN protocol. Alternatively, another communication protocol now known or later developed can be used.

As shown, the mobile UE device 501 comprises a processor 503 coupled to a memory 507 and a Transceiver 504. The memory 507 stores (software) applications 505 for execution by the processor 503. The applications 505 could comprise any known or future application useful for individuals or organizations. As an example, such applications 505 could be categorized as operating systems (OS), device drivers, databases, multimedia tools, presentation tools, Internet browsers, e-mailers, Voice-Over-Internet Protocol (VOIP) tools, file browsers, firewalls, instant messaging, finance tools, games, word processors or other categories. Regardless of the exact nature of the applications 505, at least some of the applications 505 may direct the mobile UE device 501 to transmit UL signals to the eNB (base-station) 502 periodically or continuously via the transceiver 504.

Transceiver 504 includes uplink logic which may be implemented by execution of instructions that control the operation of the transceiver. Some of these instructions may be stored in memory 507 and executed when needed. As would be understood by one of skill in the art, the components of the Uplink Logic may involve the physical (PHY) layer and/or the Media Access Control (MAC) layer of the transceiver 504. Transceiver 504 includes one or more receivers 520 and one or more transmitters 522. The transceivers(s) may be embodied to process a transmission signal with the slot structure as described with respect to FIGS. 2-4. In particular, as described above, a transmission signal comprises at least one data symbol and at least one RS symbol. SRS symbols are transmitted as needed by allocating a symbol space. PUCCH symbols and SRS symbols are generated as described above by using a same base sequence group index value u to select a base sequence for either type of symbol. In one embodiment, information that represents the ordered set of sequences is stored in memory 507 which is accessible by transceiver 504. Index u is then used to select or to produce the indicated sequence from the stored ordered list of sequences.

As shown in FIG. 5, the eNB 502 comprises a Processor 509 coupled to a memory 513 and a transceiver 510. The memory 513 stores applications 508 for execution by the processor 509. The applications 508 could comprise any known or future application useful for managing wireless communications. At least some of the applications 508 may direct the base-station to manage transmissions to or from the user device 501.

Transceiver 510 comprises an uplink Resource Manager 512, which enables the eNB 502 to selectively allocate uplink PUSCH resources to the user device 501. As would be understood by one of skill in the art, the components of the uplink resource manager 512 may involve the physical (PHY) layer and/or the Media Access Control (MAC) layer of the transceiver 510. Transceiver 510 includes a Receiver 511 for receiving transmissions from various UE within range of the eNB and transmitters for transmitting data and control information to the various UE within range of the eNB.

Uplink resource manager 512 executes instructions that control the operation of transceiver 510. Some of these instructions may be located in memory 513 and executed when needed. Resource manager 512 controls the transmission resources allocated to each UE that is being served by eNB 502 and broadcasts control information via the physical downlink control channel PDCCH. The transceivers(s) may be embodied to process a transmission signal with the slot structure as described with respect to FIGS. 2-4. In particular, as described above, a transmission signal may have a PUCCH symbol or an SRS symbol produced from a sequence using a same sequence group number, as described in more detail above.

As discussed above, the eNodeB must allocate PUSCH DM RS sequence groups separately from the PUCCH RS and SRS sequence groups, but the PUCCH RS and SRS can be allocated the same base sequence group or at least the same base sequence group index u in a cell. In the case of explicit sequence group signaling, this limits to two the number of base sequence group indexes that need to be broadcast in a cell by the eNodeB in support of all UL RSs.

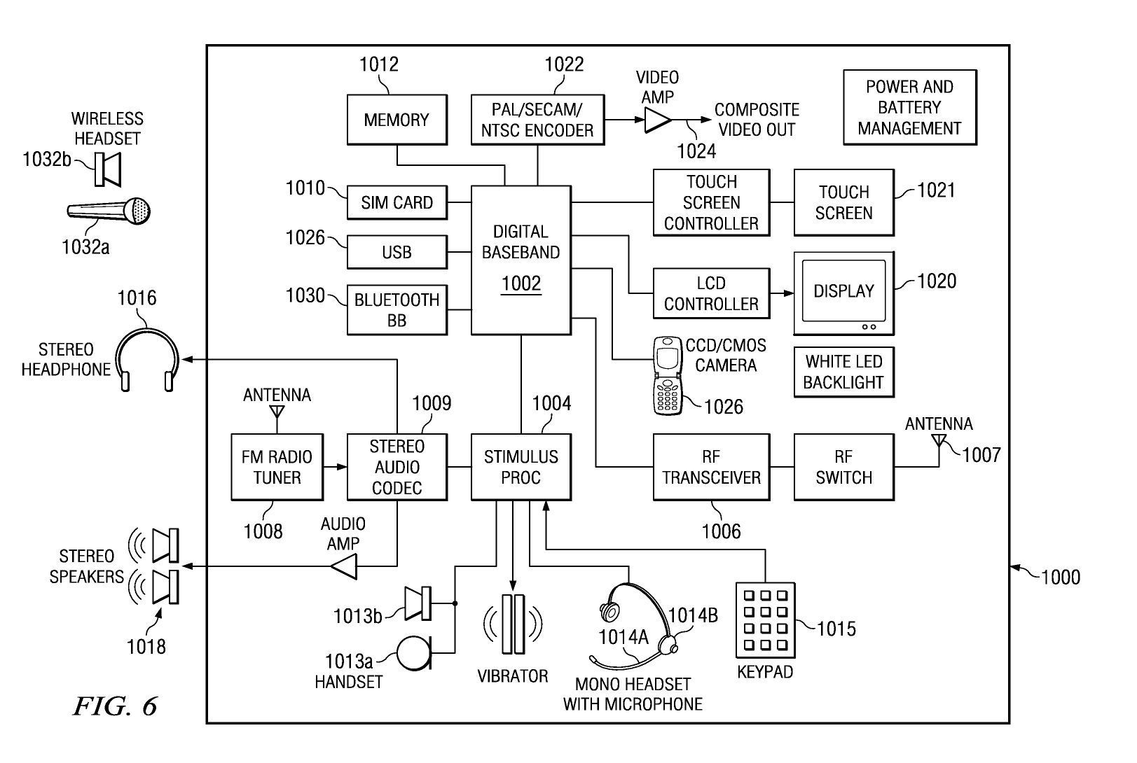

FIG. 6 is a block diagram of mobile cellular phone 1000 for use in the network of FIG. 1. Digital baseband (DBB) unit 1002 can include a digital processing processor system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 1006 includes a receiver for receiving a stream of coded data frames and commands from a cellular base station via antenna 1007 and a transmitter for transmitting a stream of coded data frames to the cellular base station via antenna 1007. Transmission of the PUSCH data is performed by the transceiver using the PUSCH resources designated by the serving eNB. Control information is transmitted using the PUCCH. In some embodiments, frequency hopping may be implied by using two or more bands as commanded by the serving eNB. In this embodiment, a single transceiver can support multi-standard operation (such as EUTRA and other standards) but other embodiments may use multiple transceivers for different transmission standards. Other embodiments may have transceivers for a later developed transmission standard with appropriate configuration. RF transceiver 1006 is connected to DBB 1002 which provides processing of the frames of encoded data being received and transmitted by the mobile UE unit 1000.

The EUTRA defines SC-FDMA (via DFT-spread OFDMA) as the uplink modulation. The basic SC-FDMA DSP radio can include discrete Fourier transform (DFT), resource (i.e. tone) mapping, and IFFT (fast implementation of IDFT) to form a data stream for transmission. To receive the data stream from the received signal, the SC-FDMA radio can include DFT, resource de-mapping and IFFT. The operations of DFT, IFFT and resource mapping/de-mapping may be performed by instructions stored in memory 1012 and executed by DBB 1002 in response to signals received by transceiver 1006.

The transceivers(s) are embodied to process a transmission signal with the slot structure as described with respect to FIGS. 2-5. In particular, as described above, a transmission signal comprises at least one data symbol and at least one RS symbol. An exemplary transmission signal is shown in FIG. 2. The transceiver performs selection of the CAZAC-like (e.g. ZC or extended ZC or zero-autocorrelation QPSK computer-generated) base sequence using a CAZAC-like Root Sequence Selector using a base sequence index value v from the base sequence group u assigned by the eNodeB for both SRS and PUCCH transmissions in the current cell served by that eNodeB. A base sequence is selected according to index u from an ordered set of sequences as defined above. In one embodiment, information that represents the ordered set of sequences is stored in memory accessible by transceiver 1006. The information may be stored as a table, for example. Index u is then used to produce the indicated sequence from the stored information representing an ordered list of sequences.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1026, or from other sources such as USB 1026. DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder unit 1022 can provide encoding according to PAL/SECAM/NTSC video standards.

As used herein, the terms “applied,” “coupled,” “connected,” and “connection” mean electrically connected, including where additional elements may be in the electrical connection path. “Associated” means a controlling relationship, such as a memory resource that is controlled by an associated port.

While the invention has been described with reference to illustrative embodiments, this description is not intended to be construed in a limiting sense. Various other embodiments of the invention will be apparent to persons skilled in the art upon reference to this description. For example, a larger or smaller number of symbols then described herein may be used in a slot. Slot durations different from 0.5 ms may be chosen.

It is therefore contemplated that the appended claims will cover any such modifications of the embodiments as fall within the true scope and spirit of the invention.

What is claimed is:

1. A method for transmission in a wireless network, comprising:
receiving an indication of a sequence group number u, wherein physical uplink control channel (PUCCH) sequences are divided into groups having at least one sequence each and wherein sounding reference signal (SRS) sequences are divided into groups having at least one sequence each;
producing a sequence from an SRS sequence group with the sequence group number u when an SRS is to be transmitted;
producing a sequence from a PUCCH sequence group with the sequence group number u when a PUCCH symbol is to be transmitted; and
producing a transmission signal using the produced sequence.

2. Method of claim 1; wherein producing a sequence from the SRS sequence group is produced using the SRS sequence group with group number u and using a sequence number v; wherein v is a sequence number within the group u.

3. Method of claim 2; further comprising: producing a generating index n from u and v; wherein the sequence is produced using the generating index n.

4. Method of claim 2; wherein producing a sequence from the PUCCH sequence group is produced using the PUCCH sequence group with group number u and using a stored look-up table, wherein the stored look-up table is accessed using the number u.

5. The method of claim 1, wherein the SRS group with group number u comprises exactly one sequence; and wherein the PUCCH group with group number u comprises exactly one sequence.

6. The method of claim 2, wherein the SRS group with group number u comprises exactly two sequences; and wherein the PUCCH group with group number u comprises exactly one sequence.

7. Method of claim 6; wherein the two sequences from the SRS group with group number u are identified using the sequence number v; wherein v is selected from the set comprising of {0,1}; and wherein v is configured to a default value of v=0.

8. Method of claim 6; wherein the two sequences from the SRS group with group number u are identified using the sequence number v; wherein v is selected from the set comprising of {0,1}; and wherein v is set to be 0 for a first transmission; and wherein v is set to be 1 for a second transmission.

9. The method of claim 1, further comprising pre-storing the PUCCH sequence group with group number u in a memory.

10. The method of claim 1, further comprising pre-storing the SRS sequence group with group number u in a memory.

11. The method of claim 1; wherein receiving an indication of u comprises:
receiving an indication of a cell identity (cell ID); and
producing the group number u using the cell ID.

12. The method of claim 11; wherein receiving an indication of u further comprises producing a slot number for each slot, wherein the group number u is produced using the slot number.

13. The method of claim 12, wherein each slot is a 0.5 ms time slot.

14. A user equipment (UE) for transmission of sequences in a wireless network, comprising:
a receiver operable to receive an indication of a sequence group number, wherein physical uplink control channel (PUCCH) sequences are divided into groups having at least one sequence each and wherein sounding reference signal (SRS) sequences are divided into groups having at least one sequence each;
processing circuitry coupled to the receiver operable to produce a sequence from an SRS sequence group with the sequence group number u when an SRS is to be transmitted and operable to produce a sequence from a PUCCH sequence group with the sequence group number u when a PUCCH symbol is to be transmitted; and
a transmitter connected to the processing circuitry for transmitting a slot structure containing the produced sequence.

15. The UE of claim 14, further comprising a memory circuit coupled to the processing circuit operable to store a look-up table, wherein the stored look-up table is operable to be accessed by the processing circuitry using the number u for producing the sequence.

16. The UE of claim 14, being a cellular telephone.
